(19) United States
(12) Patent Application Publication
(10) Pub. No.: US 2008/0018276 A1
(43) Pub. Date: Jan. 24, 2008

(54) Switch For Electrical Hand Tool With Cumulative Safety Function

(75) Inventor: Heino Marten Burema, JT Mierlo (NL)

Correspondence Address: BANNER & WITCOFF, LTD., 1100 13th STREET, N.W., SUITE 1200, WASHINGTON, DC, 20005-4051, US

(73) Assignee: Electrische Apparatenfabriek Capax B.V., Eindhoven (NL)

(21) Appl. No.: 11/777,707

(22) Filed: Jul. 13, 2007

(30) Foreign Application Priority Data
Jul. 14, 2006 (NL) 20000144

(51) Int. Cl. H02P 3/00; H02B 1/24

(52) U.S. Cl. 318/365; 307/116

(57) ABSTRACT

The invention relates to a switch for controlling the power to be fed to an electric motor of an electrical hand tool, which comprises a power supply connection, a motor connection, a controllable semiconductor connected between the motor connection and the power supply connection, a control circuit for controlling the semiconductor, and a safety circuit, wherein the switch comprises a cumulation circuit which is adapted to repeatedly measure a quantity prevailing in the switch or in its vicinity, assign a count value to the measured value of the quantity, cumulate the count values and generate a signal when the cumulated count value reaches a predetermined value.

As a result of these measures the prior history of a component is included in the assessment of whether a situation is occurring which threatens the quality of this component.

The invention relates to a switch for controlling the power to be fed to an electric motor of an electrical hand tool, comprising a power supply connection, a motor connection, a controllable semiconductor connected between the motor connection and the power supply connection, a control circuit for controlling the semiconductor and a safety circuit.

Such switches are generally known. The object here of the safety circuit is to protect components of the switch, such as the semiconductor or switch contacts, from destruction as a consequence of unfavourable operating conditions, such as too great a current or too high a temperature. Such safety circuits are adapted to measure such a quantity and to generate a signal when this quantity exceeds a predetermined value. Adequate protection can hereby be obtained in many cases. In conditions where excessive wear or damage to a component or the destruction of a component also depends on events in the recent history of the component, such a safety circuit does not act sufficiently quickly to prevent such undesired situations. The present invention attempts to provide a safety circuit which obviates these drawbacks.

This object is achieved by such a switch which comprises a cumulation circuit which is adapted to repeatedly measure a quantity prevailing in the switch or in its vicinity, to assign a count value to the measured value of the quantity, cumulate the count values and generate a signal when the cumulated count value reaches a predetermined value.

As a result of these measures the prior history of a component is included in the assessment of whether a situation is occurring which threatens the quality of this component.

This measure is not only applicable here to the components forming part of the switch itself, such as the semiconductor, but also to components directly connected to the switch, such as the electric motor or—in the case of an electrical tool powered by a battery—the battery. It is precisely in the case of batteries that the recent history is an important factor in monitoring of the quality.

It is noted here that the invention can be applied in the case of both mains-powered AC tools and battery-powered DC tools.

The invention also relates to an associated method and an electrical tool provided with a switch according to the invention.

According to a first embodiment the cumulation circuit is adapted to measure the quantity to be measured instantaneously. This leads to a simple measuring configuration so that a simple sampling circuit can be used for measuring the instantaneous value.

Alternatively the cumulation circuit is adapted to integrate the quantity to be measured over a period of time. This leads to a greater accuracy as integration leads to a better simulation. Of course this embodiment requires a more elaborate analogue circuit to implement the integration, but this is at least partially compensated for by the lower requirements to the frequency of the measurements. Of course the integration may take place in the digital domain but this would lead to a measuring system having much in common with a measuring system executing a more frequent instantaneous measurement.

In the latter case the cumulation circuit may be adapted to integrate the quantity to be measured over mutually different periods of time. This allows the period of time to be adapted to the quality of the measured quantity, for instance when gradients appear, increasing the accuracy. The it is important to divide the result of the integration by the period of time concerned.

According to another embodiment, the count value is equal to a fixed positive value when the measured signal is greater than a first predetermined value of the measured quantity, and the count value is equal to a fixed negative value when the measured value is smaller than the first predetermined value of the measured quantity. This is a structurally simple embodiment which demands little of the circuits or, if this function is implemented in a programmable computer such as a microprocessor, of the computer or of the software, so that the cost price of such a circuit is low.

Yet another preferred embodiment provides the measure that the count value is equal to a fixed positive value when the measured signal is greater than a first predetermined value of the measured quantity, that the count value is equal to a fixed negative value when the measured value is smaller than a second predetermined value of the measured quantity, and that the count value is zero when the measured signal lies between the first and the second count value. A simulation is hereby obtained which is somewhat more accurate than the previous one but wherein the demands made on the required means are not very much greater.

A somewhat more specific embodiment provides the measure that the absolute values of the positive and the negative count value are equal to each other. This results in even greater simplification.

An alternative embodiment provides the measure that the absolute value of the positive count value is greater than that of the negative count value. With this measure specific properties of the component or components to be safeguarded can be incorporated into the simulation. An example hereof is the temperature of a component. A determined electric current heats a component at a determined speed or at a determined increase in temperature. When current is not flowing the component will cool at a speed which is determined by ambient conditions. These conditions are usually such that the speed at which the temperature falls is lower than that at which the temperature rises with the determined current. The said measure takes this phenomenon into account.

It is however also possible for the absolute value of the positive count value to be smaller than that of the negative count value. The situations of the component or components for safeguarding can be taken into account using this measure.

Continuing from the foregoing example, the temperature of a component will rise more rapidly in the case of a high current than in the case of a low current. This effect is discounted with a measure that the count value is equal to the difference between the measured value and a predetermined value of the measured quantity. This is because the count value, and thereby the gradient of the cumulative value, hereby becomes dependent on the measured value.

Yet another embodiment provides the measure that the switch is adapted to perform a measurement at a fixed interval. This measure also simplifies the required circuit, both when it is assembled from specific components and when the function thereof is implemented in a microprocessor.

Alternatively, another embodiment proposes that the switch is adapted, after a measurement, to perform the immediately following measurement when a period of time depending on the value measured during the first measurement has elapsed. Although the simulation is hereby improved because the gradient of the cumulative value does after all depend on the magnitude of the measured quantity, the changing measurement frequency does require more electronics.

According to a more specific embodiment, the period of time between a measurement and the immediately following measurement is proportional to the value measured during the first measurement. This measure also results in an improved simulation.

In order to prevent a meaningless negative cumulation taking place, the switch is adapted to reduce the cumulative value at a negative count value only when the cumulative value is greater than zero.

A number of measurable quantities are present in the vicinity of a switch which can be used as indicator that a situation is approaching which can adversely affect the quality of a component of the switch or of a component connected thereto. An electric current can herein be used, in particular the current flowing through the semiconductor of the switch or the motor current generally corresponding therewith. This current does after all result in the development of heat in the semiconductor which can result in a temperature which shortens the lifespan of the semiconductor. In a battery-powered tool it is also possible for the battery current to be measured. This battery current is after all a quantity which is of the greatest importance for the state of the battery and for the quality thereof. This is the case particularly, though not exclusively, for Li-ion batteries. In batteries the cumulative current value can moreover be used to make a simulation of the charged state of the battery, which can be important in optimizing the operation of the battery.

It is however also possible to make use of the temperature as quantity. A temperature relevant to the state of the semiconductor is the temperature of the semiconductor crystal. This is however not readily accessible for temperature measurements. By measuring the temperature elsewhere, for instance of a cooling plate connected to the semiconductor crystal, and making use of cumulative measurement according to the invention, a good estimate of the temperature of the crystal can be obtained, so that the power can be reduced or the switch can be switched off in good time. A similar consideration applies for the temperature of the battery in respect of the temperature of the cells. It is otherwise possible to measure other quantities, such as the electrical voltage or the relative humidity inside the switch housing.

An important condition for increasing the lifespan of the motor is the motor temperature. According to a preferred embodiment, the measured quantity is the temperature of the electric motor connected to the switch. It is pointed out here that the switch according to the invention is therefore adapted not only to safeguard components forming part of the switch itself, but also components outside the switch such as the electric motor, the battery, contacts or a heating element.

The measures which are taken when the cumulative count value has reached a predetermined value can be limited to merely generating a warning signal, but the operating situation can also be modified to a situation in which the load is decreased. It is also possible to switch off the switch.

An advantageous measure is the setting of more than one level, wherein different measures are taken at the different levels. It is thus possible for instance when a first level of the cumulative count value is reached to reduce the power of the switch and, when the second level of the cumulative count value is reached, to switch off the switch. Here the measures at the second level function as a kind of protection.

The present invention will be elucidated hereinbelow with reference to the accompanying drawings, in which:

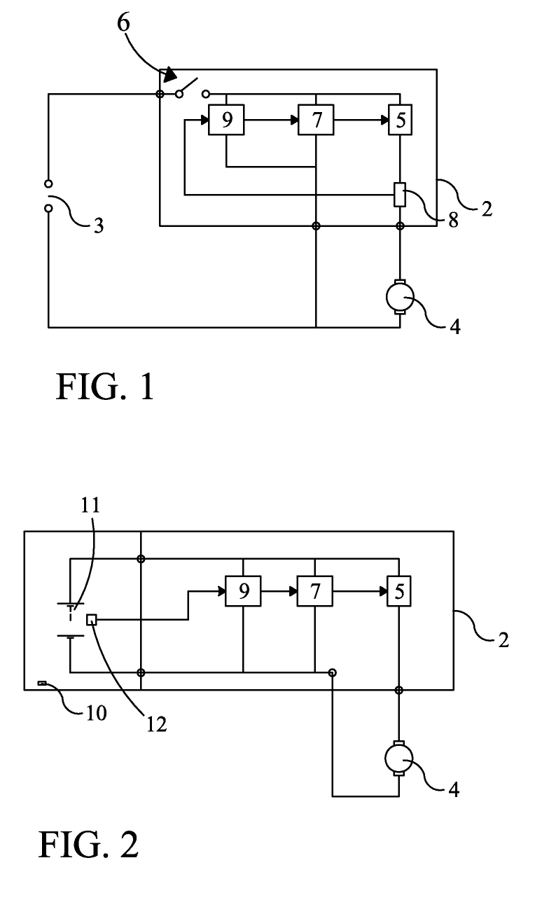

FIG. 1 shows a main current diagram of an electrical tool with a switch according to a first embodiment;

FIG. 2 shows a main current diagram of an electrical tool with a switch according to a second embodiment;

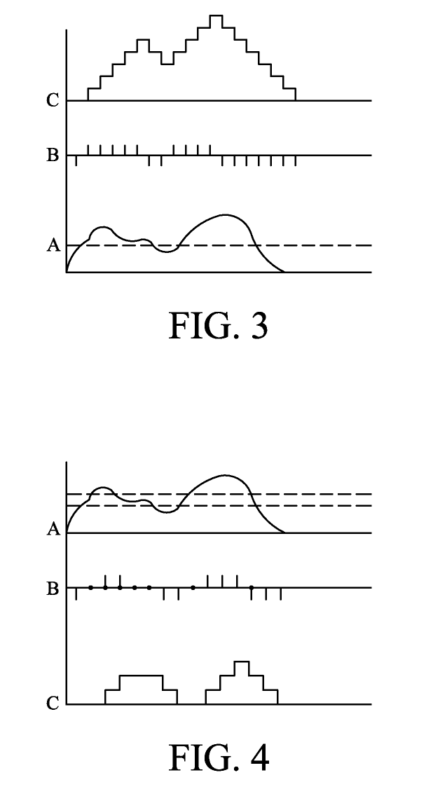

FIG. 3 shows a diagram elucidating the operation of the switch according to the invention;

FIG. 4 shows a diagram corresponding with FIG. 3 of a variant of the invention; and

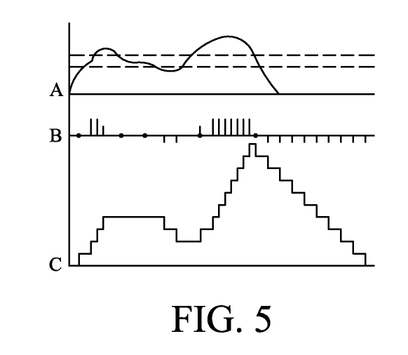

FIG. 5 shows a diagram corresponding with FIGS. 3 and 4 of another variant of the invention.

FIG. 1 shows a circuit of an electrical hand tool such as a drill. The circuit comprises a switch designated in its entirety with 2, a connection 3 for mains power supply and an electric motor 4. Switch 2 comprises a semiconductor element 5 such as a thyristor and a mechanical switch 6. Electric motor 4, semiconductor switching element 5, mechanical switch 6 and the mains power supply connection are connected in series in the manner of a prior art switch. Switch 2 also comprises a control circuit 7. The parts of the switch described up to this point form part of the prior art.

The invention provides for the arrangement of a current measuring element 8, for instance in the form of a resistor with a low ohmic value and a cumulation circuit 9. Cumulation circuit 9 is adapted to repeatedly perform a measurement of the current flowing through current measuring element 8; in other words to sample this current. This thus obtained sample value is then converted by cumulation circuit 9 into a count value, for which purpose algorithms to be elucidated below can be used. The thus obtained count values are cumulated in cumulation circuit 9 and, when a predetermined cumulation value is reached, cumulation circuit 9 generates a signal to control circuit 7 which is used for instance to switch off the switch or to control the semiconductor 5 such that the current flowing through the semiconductor is reduced. Other operations are not precluded.

It is noted by the way that the measurement is an operation which takes place periodically. It is necessary here to take into account the periodicity of the switching operations of the thyristor, this periodicity depending on the frequency of the mains power supply in order to prevent a synchronization occurring which would disrupt the sampling as a result of a measurement always taking place at the same phase.

It is however also possible that the cumulation circuit 9 is adapted to integrate the current during a certain short period of time and to compare this value with a predetermined value. Preferably use is made of a same period of time as during which the current is integrated and measured but it is also possible that these periods of time are mutually different, which can be compensated for in the next process, for instance to divide the integrated value by the period of time during which the integration took place.

The above stated embodiment relates to a mains-powered tool, wherein the cumulation circuit is adapted to measure the current flowing through the semiconductor and the motor. FIG. 2 shows an embodiment which is adapted for power supply by a rechargeable battery, wherein the temperature is measured instead of a current. The relevant circuit therefore comprises a battery unit 10 which incorporates a number of battery cells 11, as well as a temperature sensor 12 for measuring the temperature of cells 11. In this embodiment the cumulation circuit is also adapted to perform an algorithm which will be elucidated below. While the mains frequency is not a factor in this circuit, the switching frequency of the semiconductor 4, for instance a GTO or a FET, is however a relevant factor.

The operation of cumulation circuit 9 in both circuits elucidated in the foregoing will be discussed with reference to FIG. 3. FIG. 3A herein shows a graph of the measured current. The relevant current is measured, or actually sampled, periodically and the thus obtained sample value is converted into a count value as shown in FIG. 3B. This count value is derived in the present case from the measured value by making use of the reference current value shown in FIG. 3A. When the measured current is greater than the reference current value a positive count value is assigned, and when the measured current is smaller than this reference current value a negative count value is assigned. In the present case the absolute value of the positive and the negative count value is the same. The thus formed count values are cumulated as shown in FIG. 3C. It is assumed here that the cumulation value is a measure of an adverse state for the semiconductor, in the present case the temperature of the semiconductor as caused by the current flowing through the semiconductor. When the cumulation value reaches a predetermined value, an operation takes place as already explained, such as the switch being switched off.

Besides it is also possible to make use of a integration of the quantity to be measured incorporated into the measurement.

This embodiment makes use of a fixed sampling frequency; it is however also possible to make use of a variable sampling frequency, for instance a sampling frequency dependent on the measured value. In such a situation the period of time between the measurement and the subsequent measurement depends on the measured value. The more extreme the measured value, this being after all an indication of dynamic behaviour, the shorter the period of time which will generally be chosen here until the subsequent measurement.

FIG. 4 shows an embodiment wherein the count value can assume not only a positive or a negative value but also the value zero. In some situations a better simulation of the phenomena can hereby be obtained.

FIG. 5 finally shows an embodiment where there is a variable sampling; when the measured value exceeds a predetermined value, the period of time between samplings is halved.

It will be apparent that there are numerous other possibilities of algorithms performed by the cumulation circuit, also subject to the application and the dynamic behaviour of the quantity to be monitored.

1. Switch for controlling the power to be fed to an electric motor of an electrical hand tool, comprising:
a power supply connection;
a motor connection;
a controllable semiconductor connected between the motor connection and the power supply connection;
a control circuit for controlling the semiconductor; and
a safety circuit, characterized in that the switch comprises a cumulation circuit which is adapted to:
repeatedly measure a quantity prevailing in the switch or in its vicinity;
assign a count value to the measured value of the quantity;
cumulate the count values; and
generate a signal when the cumulated count value reaches a predetermined value.

2. Switch as claimed in claim 1, characterized in that the cumulation circuit is adapted to measure the quantity to be measured instantaneously.

3. Switch as claimed in claim 1, characterized in that the cumulation circuit is adapted to integrate the quantity to be measured over a period of time.

4. Switch as claimed in claim 2, characterized in that the cumulation circuit is adapted to integrate the quantity to be measured over mutually different periods of time and to divide the result of the integration by the period of time concerned.

5. Switch as claimed in claim 1, characterized in that the count value is equal to a fixed positive value when the measured signal is greater than a first predetermined value of the measured quantity, and that the count value is equal to a fixed negative value when the measured value is smaller than the first predetermined value of the measured quantity.

6. Switch as claimed in claim 1, characterized in that the count value is equal to a fixed positive value when the measured signal is greater than a first predetermined value of the measured quantity, that the count value is equal to a fixed negative value when the measured value is smaller than a second predetermined value of the measured quantity, and that the count value is zero when the measured signal lies between the first and the second count value.

7. Switch as claimed in claim 5, characterized in that the absolute values of the positive and the negative count value are equal to each other.

8. Switch as claimed in claim 5, characterized in that the absolute value of the positive count value is greater than that of the negative count value.

9. Switch as claimed in claim 5, characterized in that the absolute value of the positive count value is smaller than that of the negative count value.

10. Switch as claimed in claim 1, characterized in that the count value is equal to the difference between the measured value and a predetermined value of the measured quantity.

11. Switch as claimed in claim 1, characterized in that the switch is adapted to perform a measurement at a fixed interval.

12. Switch as claimed in claim 1, characterized in that the switch is adapted, after a measurement, to perform the immediately following measurement when a period of time depending on the value measured during the first measurement has elapsed.

13. Switch as claimed in claim 12, characterized in that the period of time between a measurement and the immediately following measurement is proportional to the value measured during the first measurement.

14. Switch as claimed in claim 1, characterized in that the switch is adapted to reduce the cumulative value at a negative count value only when the cumulative value is greater than zero.

15. Switch as claimed in claim 1, characterized in that the measured quantity is an electric current inside the switch.

16. Switch as claimed in claim 1, characterized in that the measured quantity is a temperature prevailing inside the switch.

17. Switch as claimed in claim 1, characterized in that the measured quantity is the temperature of a battery connected to the switch.

18. Switch as claimed in claim 1, characterized in that the measured quantity is the temperature of the electric motor connected to the switch.

19. Switch as claimed in claim 1, characterized in that the switch is adapted to reduce the power to be fed by the switch to the electric motor upon generation of a signal at a first cumulative count value.

20. Switch as claimed in claim 1, characterized in that the switch is adapted to switch off the switch upon generation of a signal at a second cumulative count value.

21. Combination of a switch as claimed in claim 17 and a battery.

22. Electrical hand tool, characterized by a switch as claimed in claim 1.

23. Method for operating a switch for controlling the power to be fed to an electric motor of an electrical hand tool, wherein the method comprises the following steps of:
repeatedly measuring a quantity prevailing in the switch or in its vicinity;
assigning a count value to the measured value of the quantity;
cumulating the count values; and
generating a signal when the cumulated count value reaches a predetermined value.
